(19) United States
(12) Patent Application Publication
(10) Pub. No.: US 2018/0056970 A1
(43) Pub. Date: Mar. 1, 2018

(54) DRIVING AID CONTROL APPARATUS

(71) Applicant: DENSO CORPORATION, Kariya-city (JP)

(72) Inventors: Hirotaka TOKORO, Kariya-city (JP); Hiroshi INOU, Kariya-city (JP)

(21) Appl. No.: 15/683,626

(22) Filed: Aug. 22, 2017

(30) Foreign Application Priority Data
Aug. 23, 2016 (JP) 2016-162800

(51) Int. Cl. B60W 10/20; B60W 40/072

(52) U.S. Cl. CPC B60W 10/20; B60W 40/072; B60W 2720/14; B60W 2710/207; B60W 2550/146

(57) ABSTRACT

An apparatus for performing driving aid control to cause a travel trajectory of a mobile object to follow a setpoint trajectory by transmitting a control command value to a yaw moment controller. In the apparatus, a setpoint trajectory setter sets the setpoint trajectory of the mobile object. A first control command value calculator calculates a first control command value by performing target-position following control to cause a position of the mobile object to follow a future target position of the mobile object set on the setpoint trajectory. A second control command value calculator calculates a second control command value by performing setpoint-trajectory following control based on a current lateral error that is a lateral error between a current position of the mobile object and the setpoint trajectory. A third control command value calculator calculates the control command value based on the first control command value and the second control command value.

### CROSS-REFERENCE TO RELATED APPLICATION

This application is based on and claims the benefit of priority from earner Japanese Patent Application No. 2016-162800 filed Aug. 23, 2016, the description of which is incorporated herein by reference.

### BACKGROUND

Technical Field

### The present disclosure relates to a driving aid control apparatus.

### Related Art

A vehicle driving aid system disclosed in Japanese Patent Application Laid-Open Publication No. 2015-214284 includes a controller to control behavior of a vehicle. The controller detects a position of the vehicle using a position detector, and based on the detected position, sets a target position. In addition, the controller calculates a current turning center and a target turning radius while the vehicle is turning, and calculates a control steering angle such that the turning radius converges to the target turning radius. The controller outputs a control steering angle to an actuator, thereby controlling steering of the vehicle.

However, in the presence of offset errors caused by misalignment of the position detector, such offset errors may prevent the position of the vehicle from following the target position set based on the position of the vehicle detected by the position detector.

In addition, some physical quantities difficult to detect using sensors or the like may occur in the vehicle. Such physical quantities may include a lateral slippage angle of the vehicle, a change in vehicle attitude while traveling on a canted road, and environmental factors such as side wind. The physical quantities may further include the number of passengers, a carrying capacity, a change in gripping force caused by tire exchange, changes in vehicle dimensions or characteristics caused by aging degradation. For the driving aid system disclosed in Japanese Patent Application Laid-Open Publication No. 2015-214284, it is difficult to set a control steering angle corresponding to the physical quantities in the presence of such difficult-to-detect physical quantities. Thus, it is difficult to make the position of the vehicle to follow the target position.

In view of the above, a driving aid control apparatus that can improve followability to a setpoint trajectory is desired.

### SUMMARY

The present disclosure provides an apparatus for performing driving aid control to cause a travel trajectory of a mobile object to follow a setpoint trajectory by transmitting a control command value to a yaw moment controller capable of controlling a yaw moment of the mobile object. The apparatus includes: a setpoint trajectory setter configured to set the setpoint trajectory of the mobile object; a first control command value calculator configured to calculate a first control command value by performing target-position following control to cause a position of the mobile object to follow a future target position of the mobile object set on the setpoint trajectory; a second control command value calculator configured to calculate a second control command value by performing setpoint-trajectory following control based on a current lateral error that is a lateral error between a current position of the mobile object and the setpoint trajectory; and a third control command value calculator configured to calculate a final control command value based on the first control command value and the second control command value.

In the above embodiment, a control command value used in the driving aid control is set based on both the first control command value and the second control command value, whereby the setpoint-trajectory following control, as well as the target-position following control, is performed. With such a configuration, even in cases where it is difficult for the target-position following control alone to cause the travel trajectory of the mobile object to approach the setpoint trajectory due to the presence of various disturbance factors, performing the setpoint-trajectory following control can cause the travel trajectory of the mobile object to follow the setpoint trajectory, which can improve the followability to the setpoint trajectory.

### BRIEF DESCRIPTION OF THE DRAWINGS

FIG. 1 illustrates a block diagram of a driving aid system according to a first embodiment of the present disclosure;

FIG. 2 illustrates a functional block diagram of a driving aid ECU of the first embodiment;

FIG. 3 illustrates target-position following control performed in the driving aid ECU of the first embodiment;

FIG. 4 illustrates an example of a lateral error used in setpoint-trajectory following control performed in the driving aid ECU of the first embodiment;

FIG. 5 is a flowchart of processing performed in the driving aid ECU of the first embodiment;

FIG. 6 illustrates an example of travel trajectory of a vehicle under driving aid control of the first embodiment;

FIG. 7 illustrates a functional block diagram of a driving aid ECU according to a second embodiment of the present disclosure; and

FIG. 8 illustrates a functional block diagram of a driving aid ECU according to a third embodiment of the present disclosure.

### DESCRIPTION OF SPECIFIC EMBODIMENTS

Hereinafter, exemplary embodiments of the present disclosure will be described in detail with reference to the accompanying drawings, in which like reference numerals refer to like or similar elements regardless of reference numerals and duplicated description thereof will he omitted.

### First Embodiment

A driving aid control apparatus according to a first embodiment will now be described with reference to the drawings. The driving aid control apparatus is used in a driving aid system that performs driving aid control to cause a travel trajectory of a vehicle to follow a setpoint trajectory.

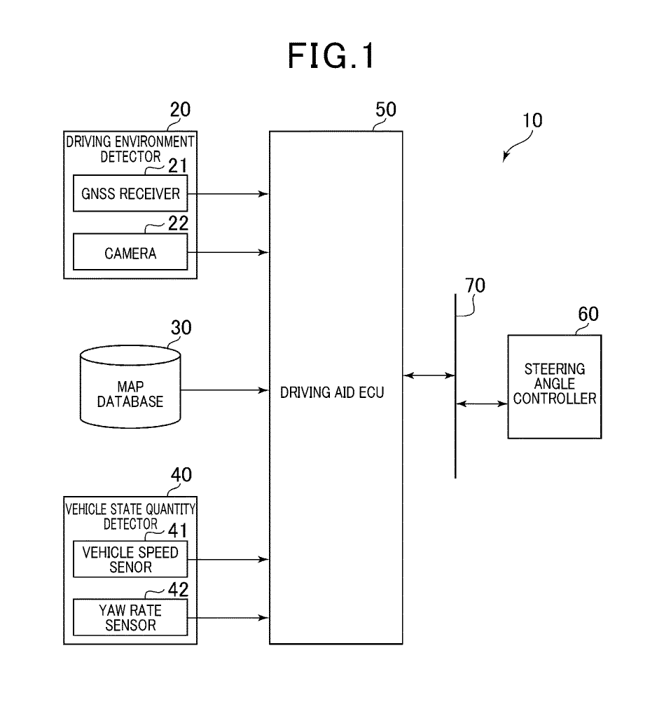

As shown in FIG. 1, the driving aid system 10 for a vehicle according to the present embodiment includes a driving environment detector 20, a map database 30, a vehicle state quantity detector 40, a driving aid electronic control unit (ECU) 50, and a steering angle controller 60. In the present embodiment, the driving aid ECU 50 serves as a driving aid control apparatus.

The driving environment detector 20 detects a position of the vehicle, a road shape ahead of the vehicle, and others. The driving environment detector 20 includes a GNSS receiver 21 and a camera 22. The GNSS receiver 21 receives navigation signals from a plurality of satellites constituting a global navigation satellite system (GNSS), and outputs the received navigation signals to the driving aid ECU 50. The camera 22 outputs to the driving aid ECU 50 a signal corresponding to image data acquired by imaging ahead of the vehicle.

The map database 30 is a database of information, such as latitudes and longitudes of roads and various facilities. Information about road shapes and lanes of roads are also registered in the map database 30, The information about the lanes includes locations and types of the lane lines or lane boundaries. The map database 30 may be dedicated to the driving aid system 10 or may be a database commonly used in a car navigation device mounted in the vehicle.

The vehicle state quantity detector 40 detects various state quantities of the vehicle. The vehicle state quantity detector 40 includes a vehicle speed sensor 41 and a yaw rate sensor 42. The vehicle speed sensor 41 detects a travel speed of the vehicle based on a rotational speed of the wheel and outputs a signal corresponding to the detected travel speed to the driving aid ECU 50. The yaw rate sensor 42 detects a yaw rate that is a rate of change of a yaw angle over time and outputs a signal corresponding to the yaw rate to the driving aid ECU 50.

The driving aid ECU 50 is configured as a microcomputer or the like that incorporates therein a central processing unit (CPU) (not shown), a read-only memory (ROM) (not shown), a random access memory (RAM) (not shown). The CPU performs driving aid control processing to cause a travel trajectory of the vehicle to follow a setpoint trajectory. The ROM stores programs and data necessary for the driving aid control. The RAM transiently stores results of the CPU.

The driving aid ECU 50 loads output signals from the GNSS receiver 21 and the camera 22. The driving aid ECU 50 acquires information of a latitude φ and longitude λ corresponding to a current position of the vehicle based on the output signals from the GNSS receiver 21. The driving aid ECU 50 acquires image data I based on the output signal from the camera 22, The driving aid ECU 50 acquires map data M from the map database 30. The driving aid ECU 50 sets a setpoint trajectory La of the vehicle based on the acquired information from the GNSS receiver 21, the camera 22, and the map database 30.

The driving aid ECU 50 further loads output signals from the vehicle speed sensor 41 and the yaw rate sensor 42. The driving aid ECU 50 acquires information of a travel speed V and a yaw rate Y of the vehicle based on the output signals from the vehicle speed sensor 41 and the yaw rate sensor 42.

Based on the setpoint trajectory La, the travel speed V and the yaw rate Y, the driving aid ECU 50 calculates a steering angle command value δ for causing the actual travel trajectory of the vehicle to follow the setpoint trajectory La. The steering angle command value δ is a target steering angle. In the present embodiment, the steering angle command value δ corresponds to a final control command value.

The driving aid ECU 50 is communicatively connected to the steering angle controller 60 via an onboard network 70. The driving aid ECU 50 transmits via the onboard network 70 information of the steering angle command value δ to the steering angle controller 60, thereby performing the driving aid control to cause the travel trajectory of the vehicle to follow the setpoint trajectory.

The steering angle controller 60 is capable of controlling the steering angle of the vehicle. An electrically-powered steering device that applies an assistive torque to a steering shaft to thereby assist the driver of the vehicle in steering may be used as the steering angle controller 60. The steering angle controller 60 receives the steering angle command value δ from the driving aid ECU 50 via the onboard network 70, and performs steering angle feedback control to cause an actual steering angle to follow the steering angle command value δ. In the present embodiment, the steering angle controller 60 serves as a yaw moment controller capable of controlling a yaw moment of the vehicle.

The driving aid control to be performed in the driving aid ECU 50 will now be described in more detail.

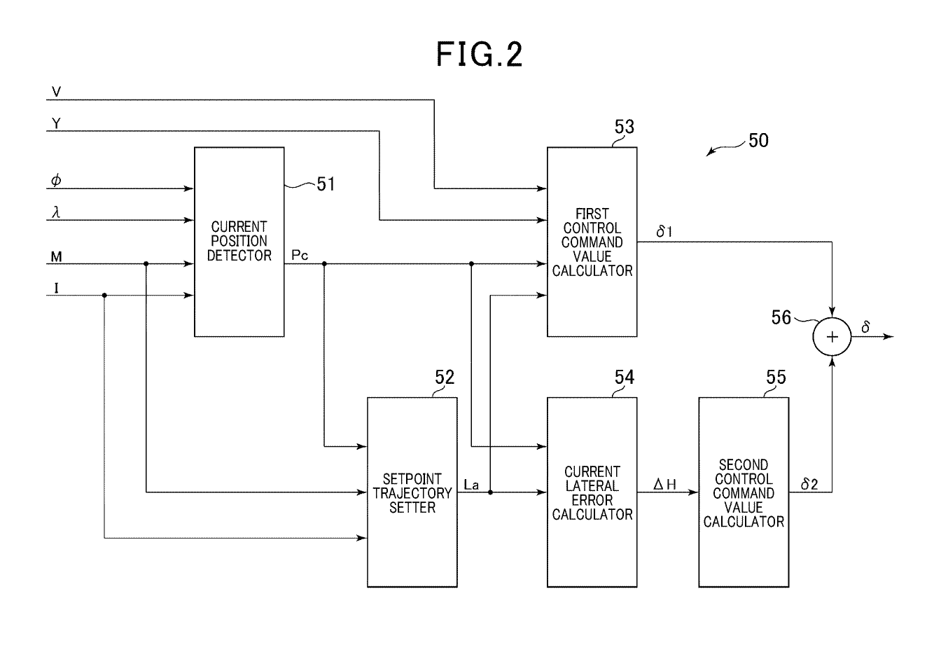

As shown in FIG. 2, the driving aid ECU 50 includes a current position detector 51, a setpoint trajectory setter 52, a first control command value calculator 53, a current lateral error calculator 54, a second control command value calculator 55, and an adder 56.

The current position detector 51 receives information, such as a latitude φ and longitude λ corresponding to a current position of the vehicle, map data M, and image data I. The current position detector 51 detects a current position Pc of the vehicle based on the received information, More specifically, the latitude φ and longitude λ represent an absolute position on the map data M. The current position detector 51 translates the absolute position of the vehicle represented by the latitude φ and longitude λ on the map data M to a position in a vehicle's fixed coordinate system to acquire a relative positional relationship between each lane registered in the map data M and the vehicle. In addition, the current position detector 51 image-processes the image data in an appropriate manner to detect a position of a lane ahead of the vehicle, thereby acquiring a relative positional relationship between the lane and the vehicle. The current position detector 51 uses at least one of the relative positional relationship between the lane and the vehicle acquired from the map data M and the relative positional relationship between the lane and the vehicle acquired from the image data I to detect a current position Pc of the vehicle. Subsequent processing will be performed using the vehicle's fixed coordinate system.

The setpoint trajectory setter 52 receives information, such as the current position Pc of the vehicle detected by the current position detector 51, the map data M and the image data I. The setpoint trajectory setter 52 sets a setpoint trajectory based on the received information. For example, the setpoint trajectory setter 52 detects positions of lane lines that demarcate the lane that the vehicle is traveling in based on the map data M and the image data I, and sets a setpoint trajectory La to a center line between the two-lane lines.

The first control command value calculator 53 receives information, such as the current position Pc of the vehicle detected by the current position detector 51, the setpoint trajectory La set by the setpoint trajectory setter 52, the travel speed V, and the yaw rate Y. Based on the received information, the first control command value calculator 53 calculates a first steering angle command value φ1 by performing target-position following control for causing the position of the vehicle to follow or approach a future target position Pc* on the setpoint trajectory La. In the present embodiment, the first steering angle command value δ1 corresponds to a first control command value. A control method disclosed in Japanese Patent Application Laid-Open Publication No. 2015-214284 may be used as the target-position following control.

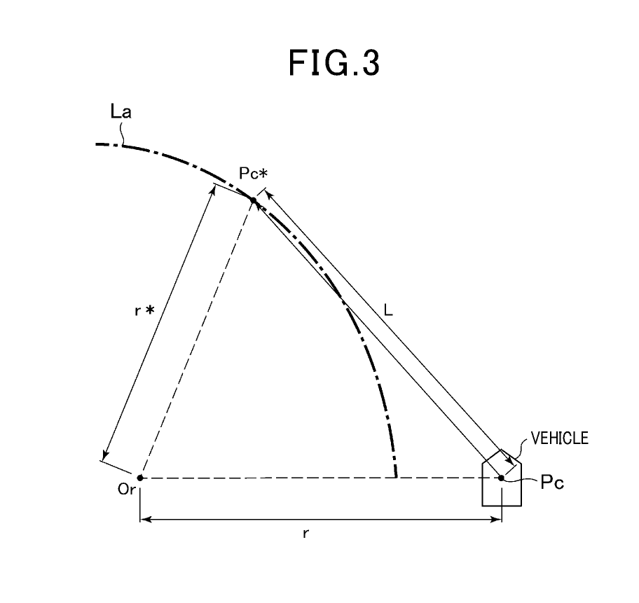

According to the control method disclosed in Japanese Patent Application Laid-Open Publication No. 2015-214284, as shown in FIG. 3, it is assumed that, when the vehicle is located at a position Pc during traveling around a curve, a setpoint trajectory La is set to a dashed-dotted curved line. The first control command value calculator 53 sets a future target position Pc* to a position that is on and along the setpoint trajectory La and spaced apart from the current position Pc of the vehicle by a predetermined distance L. The predetermined distance L may be a distance that the vehicle can travel at a travel speed V for a predetermined time period.

The first control command value calculator 53 calculates a current position of the turning center Or and a current turning radius R based on the travel trajectory of the vehicle within the last predetermined time period and a current speed V and yaw rate Y of the vehicle. The travel trajectory of the vehicle within the last predetermined time period may be calculated based on time-sequence data of the instantaneous positions Pc of the vehicle within the last predetermined time period.

The first control command value calculator 53 calculates a turning radius when the vehicle is located at the target position Pc* as a target turning radius r*. For example, the first control command value calculator 53 calculates the target turning radius r* as a distance from the turning center Or to the target position Pc* assuming that the turning center when the vehicle is located at the target position Pc* coincides with the turning center Or when the vehicle is located at the current position Pc.

The first control command value calculator 53 performs the target-position following control that is feedback control based on an error between the calculated current turning radius r and the target turning radius r* to thereby calculate a first steering angle command value δ1. In the target-position following control, the first steering angle command value δ1 may be calculated by multiplying the error between the calculated current turning radius r and target turning radius r* by a predetermined control gain. Such feedback control allows the position of the vehicle to follow the future target position Pc* set on the setpoint trajectory La.

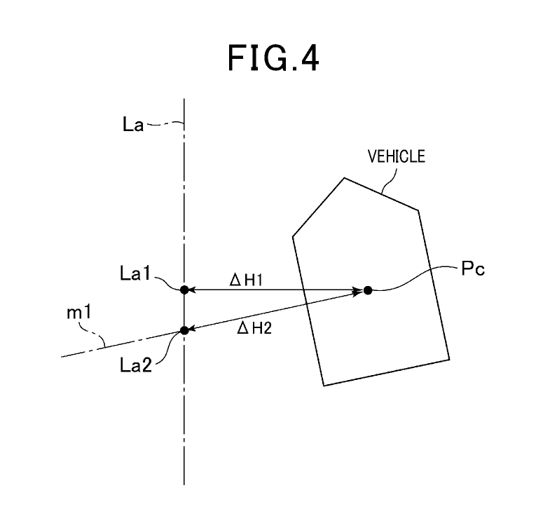

As shown in FIG. 2, the current lateral error calculator 54 receives information, such as the current position Pc of the vehicle detected by the current position detector 51 and the setpoint trajectory La set by the setpoint trajectory setter 52. Based on the received information, the current lateral error calculator 54 calculates a current lateral error ΔH that is an error between the current position Pc of the vehicle and the setpoint trajectory La. For example, as shown in FIG. 4, the current lateral error calculator 54 may use a distance ΔH1 between the current position Pc and a position La1 on the setpoint trajectory La as a current lateral error ΔH, where the position La1 is closest to the current position Pc. Alternatively, the current lateral error calculator 54 may use a distance ΔH2 between the current position Pc of the vehicle and a position La2 as a current lateral error ΔH, where the position La2 is an intersection of the setpoint trajectory La and an axis m1 laterally extending from the current position Pc of the vehicle.

As shown in FIG. 2, the second control command value calculator 55 receives information of the current lateral error ΔH calculated by the current lateral error calculator 54. The second control command value calculator 55 calculates a second steering angle command value δ2 based on the current lateral error ΔH by performing setpoint-trajectory following control to cause the current position Pc to follow or approach the setpoint trajectory La. More specifically, the second control command value calculator 55 performs feedback control including integral control based on the current lateral error ΔH, as the setpoint-trajectory following control, The second control command value calculator 55 calculates a second steering angle command value δ2 by multiplying an integrated value of the current lateral error ΔH by an integral gain Ki. In the present embodiment, the second steering angle command value δ2 corresponds to a second control command value.

The integral control is performed as the setpoint-trajectory following control, whereby a convergence time of the setpoint-trajectory following control is greater than that of the target-position following control performed by the first control command value calculator 53. Setting a time constant of the setpoint-trajectory following control performed by the second control command value calculator 55 to a value greater than a time constant of the target-position following control performed by the first control command value calculator 53 can provide a convergence time of the setpoint-trajectory following control greater than that of the target-position following control, Such time constant adjustment can be implemented by adjusting an integral gain Ki of the integral control performed by the second control command value calculator 55.

The adder 56 adds the first steering angle command value δ1 calculated by the first control command value calculator 53 and the second steering angle command value Δ2 calculated by the second control command value calculator 55 to calculate a final steering angle command value δ. The driving aid ECU 50 transmits the steering angle command value δ calculated by the adder 56 to the steering angle controller 60. In the present embodiment, the adder 56 serves as a third control command value calculator.

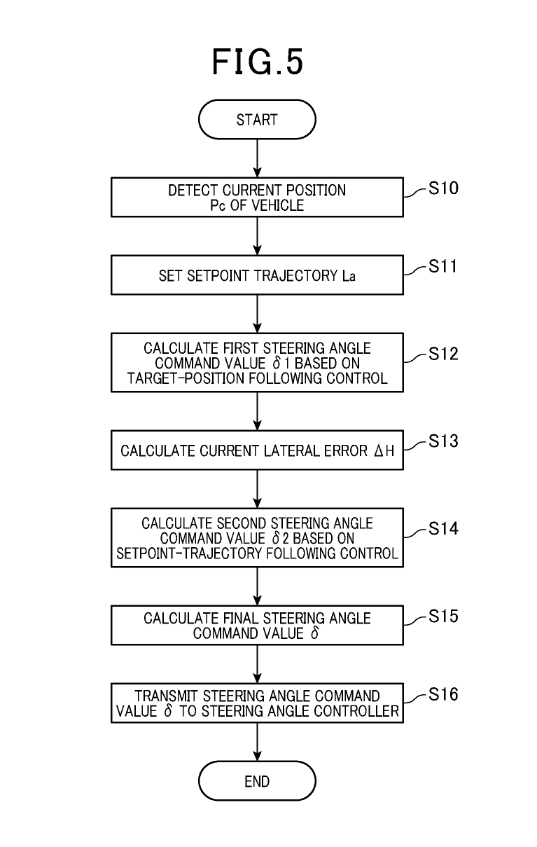

The driving aid control processing to be performed in the driving aid ECU 50 will now be described with reference to FIG. 5.

As shown in FIG. 5, in step 510, the driving aid ECU 50 detects a current position Pc of the vehicle based on information, such as a latitude φ and longitude λ of the vehicle, map data M, and image data I. In step S11, the driving aid ECU 50 sets a setpoint trajectory La of the vehicle based on information, such as the current position Pc, the map data M, and the image data I. In step S12, the driving aid ECU performs the target-position following control based on information, such as the current position Pc detected by the current position detector 51, the setpoint trajectory La set by the setpoint trajectory setter 52, the travel speed V and yaw rate Y, to calculate a first steering angle command value δ1.

In step S13, the driving aid ECU 50 calculates a current lateral error ΔH based on information, such as the current position Pc detected by the current position detector 51 and the setpoint trajectory La set by the setpoint trajectory setter 52. In step S14, the driving aid ECU 50 performs the setpoint-trajectory following control based on the current lateral error ΔH to calculate a second steering angle command value δ2.

In step S15, the driving aid ECU 50 adds the first steering angle command value δ1 and the second steering angle command value 52 to calculate a final steering angle command value δ. In step S16, the driving aid ECU 50 transmits the steering angle command value δ to the steering angle controller 60.

In the driving aid ECU 50, the current position detector 51 executes the operation of step 10. The setpoint trajectory setter 52 executes the operation of step 11. The first control command value calculator 53 executes the operation of step S12. The current lateral error calculator 54 executes the operation of step S12. The second control command value calculator 55 executes the operation of step S14. The adder 56 executes the operation of step S15.

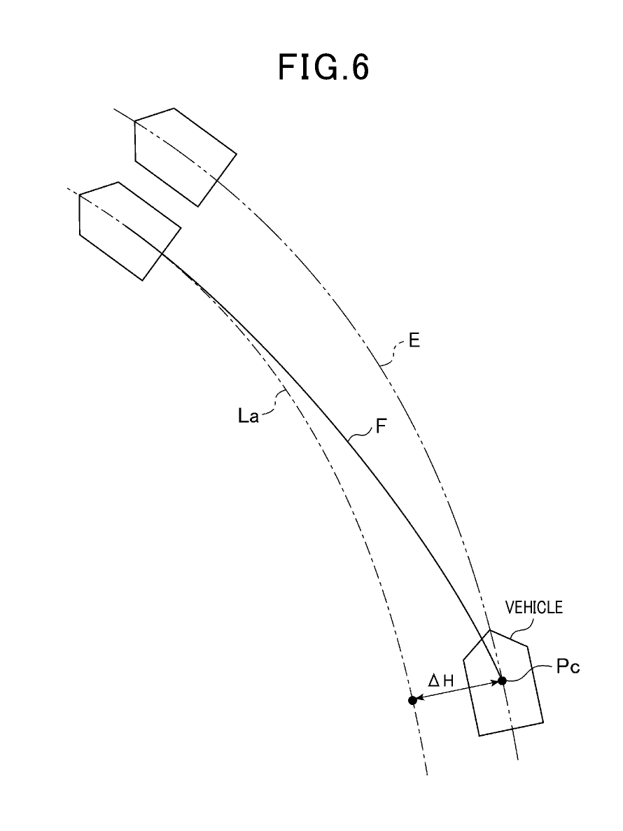

The operation of the driving aid system 10 of the present embodiment will now be described with reference to FIG. 6.

Under an assumption that, when the vehicle is traveling around a curve, a setpoint trajectory La is set to a dashed-dotted line as shown in FIG. 6, the driving aid control based on the first steering angle command value δ1 alone, that is, the target-position following control alone, may lead to an actual trajectory E of the vehicle as indicated by a dashed-two dotted line due to the presence of various disturbance factors. That is, a steady state error occurring in the target-position following control may prevent the actual travel trajectory E of the vehicle from following the setpoint trajectory La.

In the present embodiment, the driving aid system 10 further performs the setpoint-trajectory following control to calculate the second steering angle command value δ2 based on the current lateral error ΔH. The driving aid control based on the second steering angle command value δ2, that is, the setpoint-trajectory following control, can remove the steady state error of the target-position following control. As indicated by a solid line F in FIG. 6, such a configuration can cause the travel trajectory of the vehicle to follow or approach the setpoint trajectory La.

The driving aid ECU 50 of the present embodiment described as above can provide the following advantages.

(A1) The driving aid ECU 50 calculates a final steering angle command value δ for the driving aid control based on the first steering angle command value δ1 and the second steering angle command value δ2. With this configuration, not only the target-position following control based on the first steering angle command value δ1, but also the setpoint-trajectory following control based on the second steering angle command value δ2 are performed. Therefore, even in cases where it is difficult for target-position following control alone to cause the travel trajectory to follow the setpoint trajectory La due to the presence of various disturbance factors, performing the setpoint-trajectory following control can cause the travel trajectory to follow the setpoint trajectory La. Thus, the followability to the setpoint trajectory La can be improved.

(A2) The second control command value calculator 55 sets the second steering angle command value δ2 such that a convergence time of the setpoint-trajectory following control is greater than that of the target-position following control. With this configuration, the target-position following control can be dominantly performed, and remaining steady state errors in the target-position following control, if any, can be removed by performing the setpoint-trajectory following control. Thus, interference between the target-position following control and the setpoint-trajectory following control can be suppressed, which can improve the followability to the setpoint trajectory La without causing the driver and other passengers of the vehicle to feel discomfort.

(A3) The second control command value calculator 55 performs feedback control including the integral control based on the current lateral error ΔH, as the setpoint-trajectory following control. With this configuration, the second steering angle command value δ2 of the setpoint-trajectory following control is set to a value increasing with increasing duration of a steady state error in the target-position following control, which can not only remove the steady state error in the target-position following control, but also suppress oscillatory changes in the travel trajectory of the vehicle. Thus, the followability to the setpoint trajectory La can be improved.

### Second Embodiment

A second embodiment will now be described. Only differences of the second embodiment from the first embodiment will be described.

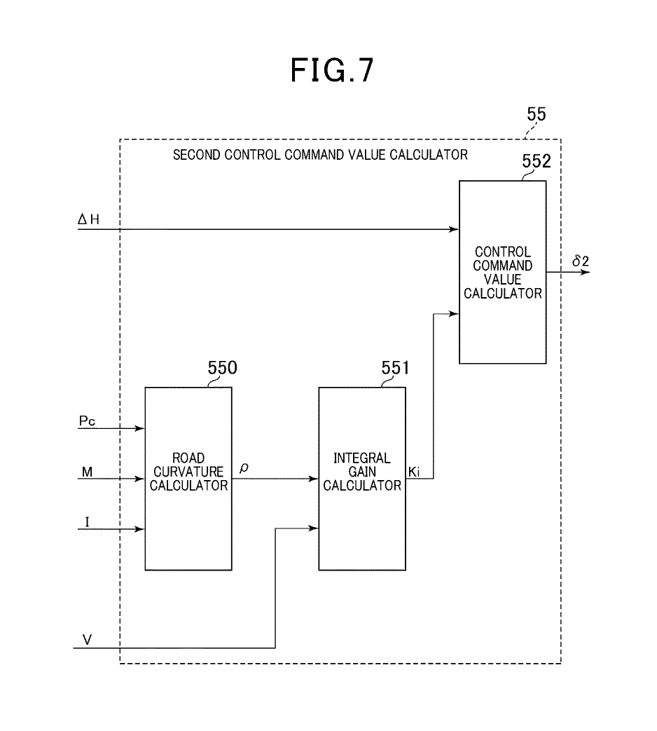

As shown in FIG. 7, a second control command value calculator 55 of the present embodiment includes a road curvature calculator 550, an integral gain calculator 551, and a control command value calculator 552.

The road curvature calculator 550 calculates a curvature of a road on which the vehicle is traveling. More specifically, the road curvature calculator 550 receives information, such as a current position Pc of the vehicle detected by the current position detector 51, the map data M, and the image data I. Based on the received information, the road curvature calculator 550 detects a shape of lane lines (or lane boundaries) that demarcate a lane in which the vehicle is traveling, and based on the detected lane line shape, a curvature ρ of the road that the vehicle is traveling on.

The integral gain calculator 551 receives information, such as the road curvature ρ calculated by the road curvature calculator 550 and a travel speed V, and based on the received information, calculates an integral gain Ki. More specifically, the integral gain calculator 551 has a three dimensional (3D) map showing a relationship between the road curvature ρ, the travel speed V, and the integral gain Ki. Based on the 3D map, the integral gain calculator 551 calculates an integral gain Ki from the road curvature ρ and the travel speed V. In the 3D map, the integral gain Ki is set to a value that increases with increasing road curvature ρ. The reason why the integral gain Ki is set to a value that increases with increasing road curvature ρ is as follows.

When the vehicle is traveling around a curve, a lateral error between the position of the vehicle and the setpoint trajectory La likely increases with increasing road curvature ρ. That is, followability to the setpoint trajectory La is liable to deteriorate. To remove such a deficiency, the 3D map is prepared such that the integral gain Ki is set to a larger value as the road curvature ρ increases.

In addition, when the vehicle is traveling around a curve, a lateral error between the position of the vehicle and the setpoint trajectory La likely increases with increasing travel speed V. To remove such a deficiency, the 3D map is prepared such that the integral gain Ki is set to a larger value as the travel speed V increases.

The control command value calculator 552 receives information, such as the integral gain Ki calculated by the integral gain calculator 551 and the current lateral error ΔH calculated by the current lateral error calculator 54. Based on the received information, the control command value calculator 552 calculates a second steering angle command value δ2 by multiplying the current lateral error ΔH by the integral gain Ki.

The driving aid ECU 50 of the present embodiment configured as above can provide additional advantages (A4) to (A8).

(A4) The second control command value calculator 55 changes the second steering angle command value δ2 based on the curvature ρ of the road that the vehicle is traveling on, More specifically, the second control command value calculator 55 sets the second steering angle command value δ2 to a larger value as the road curvature ρ increases. With this configuration, even when the vehicle is traveling around a curve where a lateral error between the position of the vehicle and the setpoint trajectory La likely increases with increasing road curvature ρ, high followability to the setpoint trajectory La can be ensured.

(A5) The second control command value calculator 55 changes the integral gain Ki based on the road curvature ρ to thereby change the second steering angle command value δ2. More specifically, the second control command value calculator 55 sets the integral gain Ki to a larger value as the road curvature ρ increases. This can readily change the second steering angle command value 52 based on the road curvature ρ.

(A7) The second control command value calculator 55 changes the second steering angle command value δ2 based on the travel speed V. More specifically, the second control command value calculator 55 sets the second steering angle command value δ2 to a larger value as the travel speed V increases. With this configuration, even when the vehicle is traveling at a speed within a high speed range where a lateral error between the position of the vehicle and the setpoint trajectory La likely increases, high followability to the setpoint trajectory La can be ensured.

(A8) The second control command value calculator 55 changes the integral gain Ki based on the travel speed V to thereby change the second steering angle command value δ2. More specifically, the second control command value calculator 55 sets the integral gain Ki to a larger value as the travel speed V increases. This can readily change the second steering angle command value δ2 based on the travel speed V.

### Third Embodiment

A third embodiment will now be described. Only differences of the third embodiment from the first embodiment will be described.

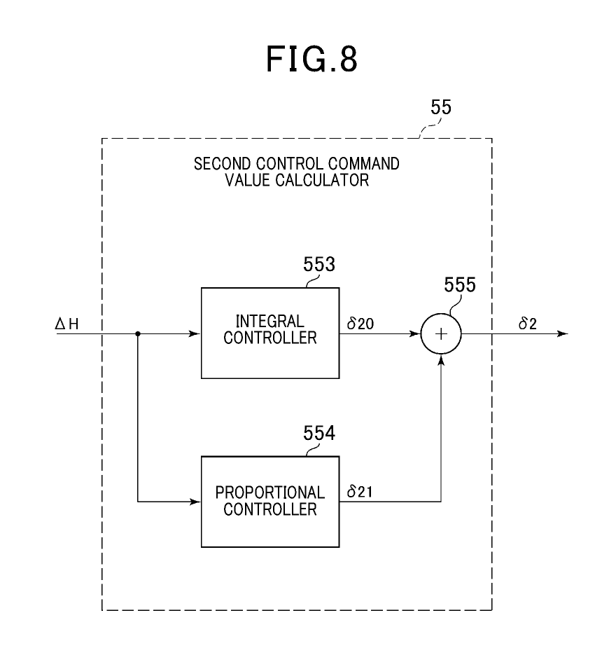

As shown in FIG. 8, a second control command value calculator 55 of the present embodiment includes an integral controller 553, a proportional controller 554, and an adder 555.

The integral controller 553 receives a current lateral error ΔH calculated by the current lateral error calculator 54. The integral controller 553 performs the integral control based on the current lateral error ΔH to calculate a steering angle command value δ20. More specifically, the integral controller 553 calculates a steering angle command value δ20 by multiplying an integrated value of the current lateral error ΔH by an integral gain Ki. The integral controller 553 may have a similar configuration to that of the second control command value calculator 55 of the second embodiment.

The proportional controller 554 receives the current lateral error ΔH calculated by the current lateral error calculator 54. The proportional controller 554 performs proportional control based on the current lateral error ΔH to calculate a steering angle command value δ21. More specifically, the proportional controller 554 calculates a steering angle command value δ21 by multiplying the current lateral error ΔH by a proportional gain Kp.

The adder 555 adds the steering angle command value δ20 calculated by the integral controller 553 and the steering angle command value δ21 calculated by the proportional controller 554 to calculate a second steering angle command value δ2.

The driving aid ECU 50 of the present embodiment configured as above can provide an additional advantage (A9).

(A9) The second control command value calculator 55 performs setpoint-trajectory following control that is feedback control including the integral control based on the current lateral error ΔH and the proportional control based on the current lateral error ΔH. This configuration can cause the proportional control to aid a response delay of the integral control, which can improve responsivity of the setpoint-trajectory following control.

### Modifications

There will now be described some modifications that may be devised without departing from the spirit and scope of the present disclosure.

(M1) In the second embodiment, the control command value calculator 55 changes the second steering angle command value δ2 by changing the integral gain Ki based on the road curvature ρ and/or the travel speed V. In an alternative embodiment to the second embodiment, the control command value calculator 55 may calculate a correction value based on the road curvature ρ and/or the travel speed V, and using the calculated correction value, corrects the steering angle command value acquired by the integral control, thereby calculating the second steering angle command value δ2.

(M2) In the second embodiment, the second control command value calculator 55 changes the integral gain Ki based on the road curvature ρ and/or the travel speed V. In an alternative embodiment to the second embodiment, the second control command value calculator 55 may change the integral gain Ki based on the travel speed V and/or various parameters correlated with the road curvature ρ, such as a curvature radius of the road.

(M3) In an alternative embodiment to the third embodiment, the proportional controller 554 may change the proportional gain Kp based on the road curvature ρ and/or the travel speed V. More specifically, the proportional controller 554 may set the proportional gain Kp to a larger value as the road curvature ρ increases. In addition, the proportional controller 554 may set the proportional gain Kp to a larger value as the travel speed V increases.

(M4) Methods used by the current position detector 51 to detect the current position Pc of the vehicle may be changed as appropriate. For example, the current position detector 51 may detect the current position Pc of the vehicle based on lane lines detected by the laser radar device or the millimeter-wave radar. The current position detector 51 may estimate a current position Pc of the vehicle based on dead reckoning based on a travel speed V detected by the travel speed sensor 41 and a yaw rate Y detected by the yaw rate sensor 42. The current position detector 51 may estimate a current position Pc of the vehicle based on combinations of various vehicle state quantities, such as the image data I, a travel speed V, a yaw rate Y, an acceleration, a steering angle, and a slip angle.

(M5) The first control command value calculator 53 may calculate a current position of the turning center Or and a turning radius r using not only a travel speed V and a yaw rate Y, but also a lateral and a longitudinal accelerations of the vehicle. This can improve the accuracy of calculating the turning center Or and the turning radius r.

(M6) The method of the target-position following control performed by the first control command value calculator 53 may be changed as appropriate. For example, the first control command value calculator 53 may calculate the first steering angle command value δ1 using a look-ahead model, a primary predictive model, a secondary predictive model or the like. The look-ahead model is a control method based on a lateral error between the setpoint trajectory La and a point of regard that is located at a predetermined distance from the current position Pc in the travel direction of the vehicle. The primary predictive model and the secondary predictive model are control methods based on a future lateral error that is an error between the setpoint trajectory La and a predictive position of the vehicle after a predetermined period of time has elapsed and is calculated based on predefined vehicle state quantities. In the primary predictive model, a linear expression with the vehicle state quantities as variables is used, where the linear expression represents a relationship between the future lateral error and the vehicle state quantities. In the secondary predictive model, a quadratic expression with the vehicle state quantities as variables is used, where the quadratic expression represents a relationship between the future lateral error and the vehicle state quantities.

(M7) The second control command value calculator 55 may change the second steering angle command value δ2 in response to a travel situation of the vehicle. For example, when determining that the vehicle is traveling on a two-way road, the second control command value calculator 55 may set the integral gain Ki to a larger value to reduce a convergence time of the setpoint-trajectory following control.

(M8) Methods used by the second control command value calculator 55 to calculate the second steering angle command value δ2 may be changed as appropriate. Any method may be used by the second control command value calculator 55 to set the second steering angle command value δ2 such that the convergence time of the setpoint-trajectory following control is greater than that of the target-position following control, which can interference between the target-position following control and the setpoint-trajectory following control.

(M9) The steering angle controller 60 is a device to correct the travel trajectory of the vehicle by generating a yaw moment applied to the vehicle. Such a device is not limited to the steering angle controller 60. Instead of using the steering angle controller 60, a device may be used that is configured to change the distribution of driving or braking forces to the wheels of the vehicle to thereby generate a yaw moment applied to the vehicle.

(M10) Methods used by the setpoint trajectory setter 52 to set the setpoint trajectory La may be changed as appropriate. For example, to support a lane change, the setpoint trajectory setter 52 may set the setpoint trajectory La to cross a lane line between different lanes. The setpoint trajectory setter 52 may detect an obstacle to travel of the vehicle based on the current position Pc, the map data M, and the image data I, and may set the setpoint trajectory La that can avoid the obstacle. The setpoint trajectory setter 52 may calculate a plurality of setpoint trajectory La candidates and then select one of the plurality of setpoint trajectory La candidates as a setpoint trajectory La to be traveled.

(M11) In each of the embodiments described above, the map database 30 used in the driving aid system 10 is a database mounted in a vehicle. Alternatively, the map database 30 may be a map database that is registered in and downloaded from a server.

(M12) In each of the embodiments described above, the driving aid ECU 50 calculates the steering angle command value δ. Alternatively, the driving aid ECU 50 may calculate an arbitrary control command value that allows a steering angle of the vehicle to be controlled. Such a control command value may include a control command value of assistive torque to be applied from a motor to a steering shaft. In addition, types of the first and second control command values respectively calculated by the first control command value calculator 53 and the second control command value calculator 55 may he changed depending on a type of control command value calculated by the driving aid ECU 50.

(M13) Methods used by the driving aid ECU 50 to detect the travel speed V and the yaw rate Y may be changed as appropriate. For example, the driving aid ECU 50 may detect the travel speed V using a GNSS speedometer. Alternatively, the driving aid ECU 50 may detect the travel speed V based on an absolute speed acquired from the image data I of the camera 22. The driving aid ECU 50 may detect the yaw rate Y based on a speed difference between the left and right wheels.

(M14) In each of the embodiments described above, the driving aid ECU 50 is applied to every automobile. Alternatively, the driving aid ECU 50 configured as above may be applied to any other type of vehicle, such as a motorcycle or a bicycle.

(M15) The means and/or functions provided by the driving aid ECU 50 can be provided by software stored in a non-transitory computer-readable storage medium and a computer executing it, software only, hardware only, or a combination thereof. For example, when the driving aid ECU 50 is provided by an electronic circuit which is hardware, it can be provided by a digital circuit including a number of logic circuits or an analog circuit.

(M16) The embodiments of the present disclosure have been described with reference to specific examples. However, the disclosure is not limited to those specific examples. Any design modification applied to such specific examples by a person skilled in the art is encompassed in the scope of the present disclosure, as long as it has the features of the present disclosure. Each element included in each of the above-mentioned specific examples, as well as the arrangement, are not limited to those illustrated in the specific examples and may be arbitrarily changed.

What is claimed is:

1. An apparatus for performing driving aid control to cause a travel trajectory of a mobile object to follow a setpoint trajectory by transmitting a control command value to a yaw moment controller capable of controlling a yaw moment of the mobile object, the apparatus comprising:
a setpoint trajectory setter configured to set the setpoint trajectory of the mobile object;
a first control command value calculator configured to calculate a first control command value by performing target-position following control to cause a position of the mobile object to follow a future target position of the mobile object set on the setpoint trajectory;
a second control command value calculator configured to calculate a second control command value by performing setpoint-trajectory following control based on a current lateral error that is a lateral error between a current position of the mobile object and the setpoint trajectory; and
a third control command value calculator configured to calculate a final control command value based on the first control command value and the second control command value.

2. The apparatus according to claim 1, wherein the second control command value calculator is configured to set the second steering angle command value such that a convergence time of the setpoint-trajectory following control performed is greater than that of the target-position following control.

3. The apparatus according to claim 1, wherein the second control command value calculator is configured to change the second control command value based on a curvature of a road on which the mobile object is traveling.

4. The apparatus according to claim 1, wherein the second control command value calculator is configured to change the second control command value based on a travel speed of the mobile object.

5. The apparatus according to claim 1, wherein the second control command value calculator is configured to perform feedback control including integral control based on the current lateral error, as the setpoint-trajectory following control.

6. The apparatus according to claim 5, wherein the second control command value calculator is configured to change an integral gain of the integral control based on a curvature of a road on which the mobile object is traveling.

7. The apparatus according to claim 5, wherein the second control command value calculator is configured to change an integral gain of the integral control based on a travel speed of the mobile object.

8. The apparatus according to claim 5, wherein the second control command value calculator is configured to perform feedback control including the integral control and proportional control based on the current lateral error, as the setpoint-trajectory following control.
